(19) United States
(12) Patent Application Publication
(10) Pub. No.: US 2012/0291675 A1
(43) Pub. Date: Nov. 22, 2012

(54) METHODS AND PRODUCTS UTILIZING MAGNESIUM OXIDE FOR CARBON DIOXIDE SEQUESTRATION

(76) Inventors: CHRIS CAMIRE, San Jose, CA (US); Peng Lu, Bloomington, IN (US); Treavor Kendall, Menlo Park, CA (US); Martin Devenney, Mountain View, CA (US)

(21) Appl. No.: 13/440,422

(22) Filed: Apr. 5, 2012

Related U.S. Application Data
(63) Continuation-in-part of application No. 12/788,735, filed on May 27, 2010.
Application No. 12/788,735 is a division of application No. 12/486,692, filed on Jun. 17, 2009, now Pat. No. 7,754,169.
(60) Provisional application No. 61/476,516, filed on Apr. 18, 2011.

(51) Int. Cl. B01D 53/62; C04B 9/00

(52) U.S. Cl. 106/801; 423/220; 423/234; 422/168

(57) ABSTRACT

Provided are methods for sequestering carbon dioxide utilizing magnesium hydroxide. A recovery method and system for recovering a gaseous component is provided. Methods and systems may utilize an alkaline component produced by thermal activation of magnesium hydroxide. Compositions of sequestered carbon dioxide comprising magnesium carbonate or magnesium bicarbonate are provided.

### CROSS-REFERENCE TO RELATED APPLICATIONS

This application claims priority to U.S. Provisional Patent Application No. 61/476,516, filed Apr. 18, 2011, which is incorporated herein by reference in its entirety. This application is a Continuation-in-part to U.S. patent application Ser. No. 12/788,735, filed May 27, 2010, which is a divisional of U.S. Pat. No. 7,754,169, issued Jul. 13, 2010, which are both incorporated herein by reference in their entireties.

### BACKGROUND

Methods and systems to maximize carbon sequestration are needed. Improved methods and systems for contacting gases and liquid and generating useful products from sequestered carbon dioxide may increase overall carbon sequestration from gases. Improved methods and systems for utilizing low cost feedstocks are needed to ensure that the carbon sequestration methods are economical.

### SUMMARY

Provided are methods for contacting a gas and liquid that include contacting a first gas comprising carbon dioxide with a Mg(OH)₂ to promote a reaction between carbon dioxide Mg(OH)₂ to form a first product comprising magnesium carbonate. Next, the first product may be contacted with MgO to form a second product. In some embodiments the MgO may be produced by applying thermal energy to brucite or an industrial waste comprising Mg(OH)₂. In some embodiments the first product comprises MgCO₃.xH₂O where x is any number from 1-10.

In some embodiments the first product comprises nesquehonite or amorphous magnesium carbonate. In some embodiments the second product comprises nesquehonite or amorphous magnesium carbonate. In some embodiments the second product is cementitious. In some embodiments the second product may be used to store nuclear waste. In some embodiments magnesium carbonate, (e.g., magnestite, high magnesium calcite, dolomite and the like) may be calcined to form the Mg(OH)₂ and a second gas comprising carbon dioxide. In some embodiments the magnesium carbonate is hydromagnesite. In some embodiments the first and second gas may be the same gas. In some embodiments the first product may be contacted with MgO or MgO in combination with carbon dioxide to form a second product.

In some embodiments a method of this invention comprises contacting a gas comprising carbon dioxide with an aqueous alkaline mixture comprising an alkaline metal cation; wherein contacting the gas promotes an acid-base a reaction between the carbon dioxide and the aqueous alkaline mixture to form a first product that comprises bicarbonate. Next the first product may be contacted with MgO to form a second product comprising a precipitated material. In some embodiments the MgO may be produced by applying thermal energy to Mg(OH)₂ to form MgO. In some embodiments a mixture comprising MgCO₃ may be calcined to form MgO and a second gas comprising carbon dioxide. In some embodiments the first and second gas are the same gas. In some embodiments the precipitated material comprises a magnesium carbonate in the form of A₂Mg(CO₃)₂, wherein A is an alkaline metal. In some embodiments A is sodium. In some embodiments the precipitated material comprises eitelite, baylissite, or any combination thereof. In some embodiments the precipitated material may be used as a building material. In some embodiments the precipitated material may be used as a fertilizer. In some embodiments the gas comprising carbon dioxide is a waste gas stream from an industrial plant selected from power plants, cement plants, smelters, and coal processing plants. In some embodiments the Mg(OH)₂ is from naturally occurring brucite. In some embodiments the Mg(OH)₂ is from an industrial waste source. In some embodiments the thermal energy used in this invention is waste heat from an industrial process and any of the gases of this invention are generated from the same industrial process. In some embodiments the products of this invention may be stored in an underground location.

A system of this invention may include a reaction vessel operably connected to a source of thermal energy and configured to withstand alkaline conditions and to provide thermal energy to a reaction mixture and connected to a gas liquid absorber and a source of gas comprising carbon dioxide and an output vessel. In some embodiments the gas liquid absorber may be configured to promote contact between the gas comprising carbon dioxide and the reaction mixture. In some embodiments the source of thermal energy is selected from a power plant, cement plant, or smelter. In some embodiments the source of gas and the source of thermal energy are the same.

Compositions of this invention may comprise mixed bicarbonates and carbonates associated with monovalent and divalent cations, and the composition may have a relative carbon isotope composition (δ¹³C) value that is less than −15.0‰. In some embodiments the mixed monovalent and divalent carbonate comprises eitelite, baylissite, or any combination thereof. In some embodiments composition of this invention may comprise magnesium carbonate in the form of MgCO₃.xH₂O or amorphous magnesium carbonate and wherein the composition has a relative carbon isotope composition (δ¹³C) value less than −15.00‰. In some embodiments the composition is cementitious. In some embodiments an additional metal may be part of the composition of this invention wherein the additional metal is selected from lead, arsenic, mercury and cadmium. In some embodiments the composition contains greater than 20 wt % magnesium carbonate and is cementitious and has a relative carbon isotope (δ¹³C) value of the carbon in the magnesium carbonate that is less than −15.00‰.

### DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1 illustrates a flow diagram depicting an embodiment of the invention.

FIG. 2 illustrates flow diagram depicting an embodiment of the invention comprising magnesium carbonate.

FIG. 3 illustrates a flow diagram depicting an embodiment of the invention.

FIG. 4 illustrates flow diagram depicting an embodiment of the invention comprising magnesium carbonate.

FIG. 5A illustrates a SEM image of a product of this invention.

FIG. 5B illustrates an XRD spectrum of a product of this invention.

FIGS. 6A, 6B, and 6C illustrate XRD spectra of products of this invention.

FIG. 7 illustrates FTIR spectra of products of this invention.

FIG. 8 illustrates an SEM image of a product of this invention.

### DESCRIPTION

Methods and systems are disclosed for the utilization of divalent cations for the sequestration of carbon dioxide. The methods and systems disclosed provide for the sequestration and/or precipitation of carbon containing species in a magnesium precipitate. In some embodiments the methods and systems disclosed provide for the precipitation of sequestered carbon dioxide by contact with MgO, Mg(OH)₂ or any combination thereof. MgO and or Mg(OH)₂ may be utilized in combination with carbon dioxide to form a cementitious product. In some embodiments divalent cations and monovalent cations may be combined with sequestered carbon dioxide to form a blended carbonate product (e.g., Na/MgCO₃). The methods and systems here may provide for Mg containing products derived from industrial waste gas that are useful for a variety of purposes, such as building materials, agricultural enhancements, or materials used in paper processing. Aspects of the methods and systems of this invention include the utilization of economical sources of alkalinity and the production of useful compositions that provide stable storage for waste carbon dioxide.

Before the invention is described in greater detail, it is to be understood that this invention is not limited to particular embodiments described, as such may, of course, vary. It is also to be understood that the terminology used herein is for the purpose of describing particular embodiments only, and is not intended to be limiting, since the scope of the invention will be limited only by the appended claims.

Where a range of values is provided, it is understood that each intervening value, to the tenth of the unit of the lower limit unless the context clearly dictates otherwise, between the upper and lower limit of that range and any other stated or intervening value in that stated range, is encompassed within the invention. The upper and lower limits of these smaller ranges may independently be included in the smaller ranges and are also encompassed within the invention, subject to any specifically excluded limit in the stated range. Where the stated range includes one or both of the limits, ranges excluding either or both of those included limits are also included in the invention.

Certain ranges are presented herein with numerical values being preceded by the term “about.” The term “about” is used herein to provide literal support for the exact number that it precedes, as well as a number that is near to or approximately the number that the term precedes. In determining whether a number is near to or approximately a specifically recited number, the near or approximating unrequited number may be a number, which, in the context in which it is presented, provides the substantial equivalent of the specifically recited number.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the invention, representative illustrative methods and materials are now described.

All publications, patents, and patent applications mentioned in this specification are incorporated herein by reference to the same extent as if each individual publication, patent, or patent application was specifically and individually indicated to be incorporated by reference. Furthermore, each cited publication, patent, or patent application is incorporated herein by reference to disclose and describe the subject matter in connection with which the publications are cited. The citation of any publication is for its disclosure prior to the filing date and should not be construed as an admission that the invention described herein is not entitled to antedate such publication by virtue of prior invention. Further, the dates of publication provided may be different from the actual publication dates, which may need to be independently confirmed.

It is noted that, as used herein and in the appended claims, the singular forms “a”, “an”, and “the” include plural references unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation.

As will be apparent to those of skill in the art upon reading this disclosure, each of the individual embodiments described and illustrated herein has discrete components and features which may be readily separated from or combined with the features of any of the other several embodiments without departing from the scope or spirit of the invention. Any recited method can be carried out in the order of events recited or in any other order, which is logically possible.

Materials used to produce compositions of the invention are described in a section with particular attention to sources of CO₂, divalent cations, and proton-removing agents (and methods of effecting proton removal). A description of systems that may be used to sequester carbon dioxide is also provided. Methods for generating reactive carbon sequestering solutions are provided. Methods by which materials (e.g., CO₂, divalent cations, etc.) may be incorporated into compositions of the invention are described next. Subject matter is organized as a convenience to the reader and in no way limits the scope of the invention.

### Sequestration of Carbon Dioxide

As described in commonly assigned U.S. Pat. No. 7,887,694, issued Feb. 15, 2011, herein incorporated by reference in its entirety, carbon dioxide may be sequestered by dissolving the gas in an aqueous solution Eq. 1 to produce aqueous carbon dioxide. This may be converted to carbonic acid, which will dissociate into bicarbonate ions and carbonate ions in accordance with Eq. II, depending on the pH of the solution when hydroxide ions are added to the solution Eq. III. The conversion of carbonic acid into bicarbonate and carbonate may be accomplished through the addition of a proton-removing agent (e.g., a base) (III-IV). Chemically, aqueous dissolution of CO₂ may be described by the following set of equations:

CO₂(g)→CO₂(aq) (in the presence of water) (I)

CO₂(aq)+H₂O→H₂CO₃(aq) (II)

Conversion to bicarbonate may described by the following equations:

H₂CO₃(aq)+OH⁻(aq)→HCO₃⁻(aq)+H₂O (III)

CO₂(aq)+OH⁻(aq)→HCO₃⁻(aq) (IV)

In the methods described herein, at least some of the captured carbon dioxide may be converted to bicarbonate or carbonate ions or both through the addition of proton-removing agents. The proton removing agents may comprise monovalent or divalent cations. In some embodiments the proton removing agent may comprise carbonates.

As described in detail below, contacting the alkaline solution with a source of CO₂ may employ any suitable protocol, such as for example by employing gas bubblers, contact infusers, fluidic Venturi reactors, spargers, components for mechanical agitation, stirrers, components for recirculation of the source of CO₂ through the contacting reactor, gas filters, sprays, trays, or packed column reactors, and the like, as may be convenient.

Aspects of the invention include methods for contacting a reactive solution with a gas comprising carbon dioxide to sequester carbon dioxide in a carbon containing reaction product (e.g., an aqueous solution comprising carbonic acid, bicarbonate, carbonate or combination thereof). The reactive solution may comprise sodium hydroxide, potassium hydroxide, magnesium oxide or any combination thereof. The carbon containing reaction product may be a clear liquid or a precipitate. The reaction product, (e.g., the carbonic acid, bicarbonate, carbonate, carbonate composition) may further be contacted with a source of a divalent cations such as magnesium or calcium. In some embodiments of this invention the sequestered carbon dioxide may be contacted with magnesium oxide or magnesium hydroxide to form a precipitate. In some embodiments the precipitation may comprise polymorphs of magnesium carbonate such as nesquehonite or hydromagnesite, amorphous magnesium carbonate or any combination thereof. Depending upon the sequestration condition of the carbon dioxide, the precipitation material may comprise a mixed monovalent/divalent carbonate (i.e., Eitelite=Na₂Mg(CO₃)₂, Baylissite=K₂Mg(CO₃)₂*4H₂O, Fairchildite=K₂Ca(CO₃)₂, Buetschliite=K₂Ca(CO₃)₂, Nyerereite=Na₂Ca(CO₃)₂, Zemkorite=Na₂Ca(CO₃)₂ or K₂Ca(CO₃)₂). The precipitation material may be used as a building material (e.g., cement, aggregate pozzolanic material), agricultural reagent (e.g., fertilizer), or for any useful purpose. In certain embodiments of the invention, a portion of reaction product produced by contacting carbon dioxide with a reactive solution may be placed in a storage location (e.g., in a in a subterranean site), effectively sequestering carbon dioxide in the form of any combination of a carbonic acid, bicarbonate and carbonate mixture. A portion of the reaction product material may be placed in a subterranean site and a portion may be further processed into a useful material.

“Alkaline solution” as used herein includes an aqueous composition which possesses sufficient alkalinity to remove one or more protons from proton-containing species in solution. Proton removing agents are discussed in greater detail below. The stoichiometric sum of proton-removing agents in the alkaline solution exceeds the stoichiometric sum of proton-containing agents expressed as equivalents or milliequivalents (mEq.). In some instances, the alkaline solutions of this invention have a pH that is above neutral pH (i.e., pH>7), e.g., the solutions may have a pH ranging from 7.1 to 12, such as 8 to 12, such as 8 to 11, and including 9 to 14. For example, the pH of one or more alkaline of the solution may be 9.5 or higher, such as 9.7 or higher, including 10 or higher. Contact of gases or liquids comprising carbon dioxide with a solution of this invention may convert the carbon dioxide to storage stable form such as a composition comprising carbonate, bicarbonate or any combination thereof.

As can be appreciated, other stable-storage carbonates and bicarbonate may be produced, including calcium and/or magnesium carbonate and/or bicarbonate, by adding the appropriate salt solution to replace the alkaline earth metals and preferentially precipitate the insoluble alkaline earth metal carbonate and/or bicarbonate over the more soluble alkaline metal carbonates and bicarbonates, as described in commonly assigned U.S. Pat. No. 7,735,274 supra hereby incorporated by reference in its entirety.

As described in further detail below, the invention involves the use of one or more of a source of CO₂, and one or more sources of carbon sequestering reagents comprising magnesium. The materials may be used to produce compositions comprising carbonates, bicarbonates, or combinations thereof.

### Carbon Dioxide

In some embodiments, methods of the invention include contacting a first reactive solution with a gas comprising carbon dioxide to form a product comprising water, carbonic acids, dissolved carbon dioxide, bicarbonates, or carbonates, or any combination thereof. This may be followed by contacting the product with a second reactive material comprising a divalent cation. The source of CO₂ may be any suitable source in any suitable form including, but not limited to, a gas, a liquid, a solid (e.g., dry ice), a supercritical fluid, and CO₂ dissolved in a liquid. In some embodiments, the CO₂ source is a gaseous CO₂ source. The gaseous stream may be substantially pure CO₂ or comprise multiple components that include CO₂ and one or more additional gases and/or other substances such as ash and other particulate material. In some embodiments, the gaseous CO₂ source is a waste feed (i.e., a by-product of an active process of the industrial plant) such as exhaust from an industrial plant. The nature of the industrial plant may vary, the industrial plants of interest including, but not limited to, power plants, chemical processing plants, mechanical processing plants, refineries, cement plants, smelters, steel plants, and other industrial plants that produce CO₂ as a by-product of fuel combustion or another processing step such as calcination. In some embodiments CO₂ may be produced by calcination in a cement plant or other processing plant as the calcination plant for magnesium carbonate (MgCO₃). In some embodiments MgCO₃ may provide both magnesium and carbon dioxide feedstock for methods of this invention.

Waste gas streams comprising CO₂ include both reducing (e.g., syngas, shifted syngas, natural gas, hydrogen and the like) and oxidizing condition streams (e.g., flue gases from combustion). Particular waste gas streams that may be convenient for the invention include oxygen-containing combustion industrial plant flue gas (e.g., from coal or another carbon-based fuel with little or no pretreatment of the flue gas), turbo charged boiler product gas, coal gasification product gas, shifted coal gasification product gas, anaerobic digester product gas, wellhead natural gas stream, reformed natural gas or methane hydrates, and the like. Combustion gas from any convenient source may be used in methods and systems of the invention. In some embodiments, combustion gases in post-combustion effluent stacks of industrial plants such as power plants, cement plants, smelters, and coal processing plants is used.

Thus, the waste streams may be produced from a variety of different types of industrial plants. Suitable waste streams for the invention include waste streams produced by industrial plants that combust fossil fuels (e.g., coal, oil, natural gas) or anthropogenic fuel products of naturally occurring organic fuel deposits (e.g., tar sands, heavy oil, oil shale, etc.). In some embodiments, a waste stream suitable for systems and methods of the invention is sourced from a coal-fired power plant, such as a pulverized coal power plant, a supercritical coal power plant, a mass burn coal power plant, a fluidized bed coal power plant. In some embodiments, the waste stream is sourced from gas or oil-fired boiler and steam turbine power plants, gas or oil-fired boiler simple cycle gas turbine power plants, or gas or oil-fired boiler combined cycle gas turbine power plants. In some embodiments, waste streams produced by power plants that combust syngas (i.e., gas that is produced by the gasification of organic matter, for example, coal, biomass, etc.) are used. In some embodiments, waste streams from integrated gasification combined cycle (IGCC) plants are used. In some embodiments, waste streams produced by Heat Recovery Steam Generator (HRSG) plants are used to produce compositions in accordance with systems and methods of the invention.

While industrial waste gas streams suitable for use in the invention contain carbon dioxide, such waste streams may, especially in the case of power plants that combust carbon-based fuels (e.g., coal), contain additional components such as water (e.g., water vapor), CO, NOₓ (mononitrogen oxides: NO and NO₂), SOₓ (monosulfur oxides: SO, SO₂ and SO₃), VOC (volatile organic compounds), heavy metals and heavy metal-containing compounds (e.g., mercury and mercury-containing compounds), and suspended solid or liquid particles (or both). Additional components in the gas stream may also include halides such as hydrogen chloride and hydrogen fluoride; particulate matter such as fly ash, dusts (e.g., from calcining), and metals including arsenic, beryllium, boron, cadmium, chromium, chromium VI, cobalt, lead, manganese, mercury, molybdenum, selenium, strontium, thallium, and vanadium; and organics such as hydrocarbons, dioxins, and polycyclic aromatic hydrocarbon (PAH) compounds. Suitable gaseous waste streams that may be treated have, in some embodiments, CO₂ present in amounts of 200 ppm to 1,000,000 ppm, such as 200,000 ppm to 1000 ppm, including 200,000 ppm to 2000 ppm, for example 180,000 ppm to 2000 ppm, or 180,000 ppm to 5000 ppm, also including 180,000 ppm to 10,000 ppm. Flue gas temperature may also vary. In some embodiments, the temperature of the flue gas is from 0° C. to 2000° C., such as from 60° C. to 700° C., and including 100° C. to 400° C.

### Carbon Sequestering Reagents

In some embodiments, methods of the invention include contacting a carbon sequestering reagent with a source of CO₂ to form a CO₂ sequestering composition (e.g., carbonic acid, bicarbonate, carbonate, dissolved carbon dioxide or any combination thereof. The sequestering reagent may be reactive solution that has a pH greater than 7 such as greater than 8 or greater than 9 or greater than 10 or greater than 12 or greater than 13. The sequestering reagent may be any alkaline solution for example comprising KOH, NaOH, Mg(OH)₂, Na₂CO₃ or any combination thereof. In some embodiments the sequestering reagent contains magnesium. The reactive solutions of this invention may comprise chemical agents. Chemical agents for effecting proton removal generally refer to synthetic chemical agents produced in large quantities and are commercially available or electrochemically synthesized. For example, chemical agents for removing protons include, but are not limited to, hydroxides, organic bases, super bases, oxides, ammonia, borates and carbonates. Hydroxides include chemical species that provide hydroxide anions in solution, including, for example, sodium hydroxide (NaOH), potassium hydroxide (KOH), calcium hydroxide (Ca(OH)₂), or magnesium hydroxide (Mg(OH)₂). In some embodiments, the chemical proton-removing agent may be an organic base. In some instances, the organic base may be a monocarboxylic acid anion, e.g., formate, acetate, propionate, butyrate, and valerate, among others. In other instances, the reactive organic species may be a dicarboxylic acid anion, e.g., oxalate, malonate, succinate, and glutarate, among others. In other instances, the organic base may be a phenolic compound, e.g., phenol, methylphenol, ethylphenol, and dimethylphenol, among others. In some embodiments, the organic base may be a nitrogenous base, such as ammonia or a primary amine, e.g., methyl amine, a secondary amine, e.g., diisopropylamine, a tertiary amine, e.g., diisopropylethylamine, an aromatic amine, e.g., aniline, or a heteroaromatic, e.g., pyridine, imidazole, or benzimidazole. In some embodiments, the proton-removing agent is a super base. Suitable super bases may include, but are not limited to sodium ethoxide, sodium amide (NaNH₂), sodium hydride (NaH), butyl lithium, lithium diisopropylamide, lithium diethylamide, and lithium bis(trimethylsilyl)amide. Oxides including, for example, calcium oxide (CaO), magnesium oxide (MgO), strontium oxide (SrO), beryllium oxide (BeO), and barium oxide (BaO) may be also suitable proton-removing agents that may be used.

### Magnesium Reagents

The sequestered CO₂ may be converted to compositions including precipitates or slurries comprising magnesium. In some embodiments a reactive material may be used to transform a sequestered carbon dioxide into products comprising an alkali and alkaline earth metals. The reactive material may comprise cations such as alkaline earth metals (i.e., MgO, Mg(OH)₂). The reactive material may be derived from industrial waste, mined materials or some combination thereof. In some embodiments the reactive material may be divalent containing mineral such as magnesium silicate, serpentine, basalt and the like. In some embodiments the reactive material may be magnesium carbonate. In addition to including cations of interest and other suitable metal forms, waste streams from various industrial processes or mined materials may provide proton-removing agents. Such waste streams include, but are not limited to, mining wastes; fossil fuel burning ash (e.g., combustion ash such as fly ash, bottom ash, boiler slag); slag (e.g., iron slag, phosphorous slag); cement kiln waste; oil refinery/petrochemical refinery waste (e.g., oil field and methane seam brines); coal seam wastes (e.g., gas production brines and coal seam brine); paper processing waste; water softening waste brine (e.g., ion exchange effluent); silicon processing wastes; agricultural waste; metal finishing waste; high pH textile waste; and caustic sludge. Mining wastes include any wastes from the extraction of metal or another precious or useful mineral from the earth.

In some embodiments, industrial wastes or mined products may be used to modify pH and/or convert sequestered carbon dioxide into useful products. The wastes may be red mud from the Bayer aluminum extraction process; waste from magnesium extraction from seawater such as Mg(OH)₂ or MgO (e.g., wastes found in Moss Landing, Calif.). In some embodiments the MgO may be derived from brucite mines or magnesium carbonate. In some embodiments the wastes from mining processes involving leaching may be utilized either to adjust the pH of a sequestering solution or as a reagent for forming a carbon sequestering product. For example, red mud may be used to modify pH. Fossil fuel burning ash, cement kiln dust, and slag, collectively waste sources of metal oxides may be used in alone or in combination with other proton-removing agents to provide proton-removing agents or reagents for the formation of products of this invention. Agricultural waste, either through animal waste or excessive fertilizer use, may contain potassium hydroxide (KOH) or ammonia (NH₃) or both. As such, agricultural waste may be used in some embodiments of the invention as a proton-removing agent or chemical reagent. This agricultural waste is often collected in ponds, but it may also percolate down into aquifers, where it may be accessed and used.

### Methods

In some embodiments an alkaline solution or an electrochemical reaction may be used to sequester a portion of carbon dioxide into a solution comprising carbonates, bicarbonates or any combination thereof and a divalent cation such as magnesium may be contacted with the sequestered carbon dioxide to form a blended monovalent/divalent cation carbonate (e.g., eitelite) or a divalent cation carbonate (e.g., amorphous magnesium carbonate).

Some or all of the sequestered carbon dioxide may be disposed of, e.g., by injection into a subterranean location, which may be any suitable location. In some embodiments over 10, 20, 30, 40, 50, 60, 70, 80, 90, 95, 99% of the sequestered carbon dioxide may be stored in this manner. In some embodiments over 10, 20, 30, 40, 50, 60, 70, 80, 90, 95, 99% wt. % of the sequestered carbon dioxide may be converted into a useful product. The systems and methods of this invention beneficially provide for regulating the amount and composition of sequestered carbon dioxide products.

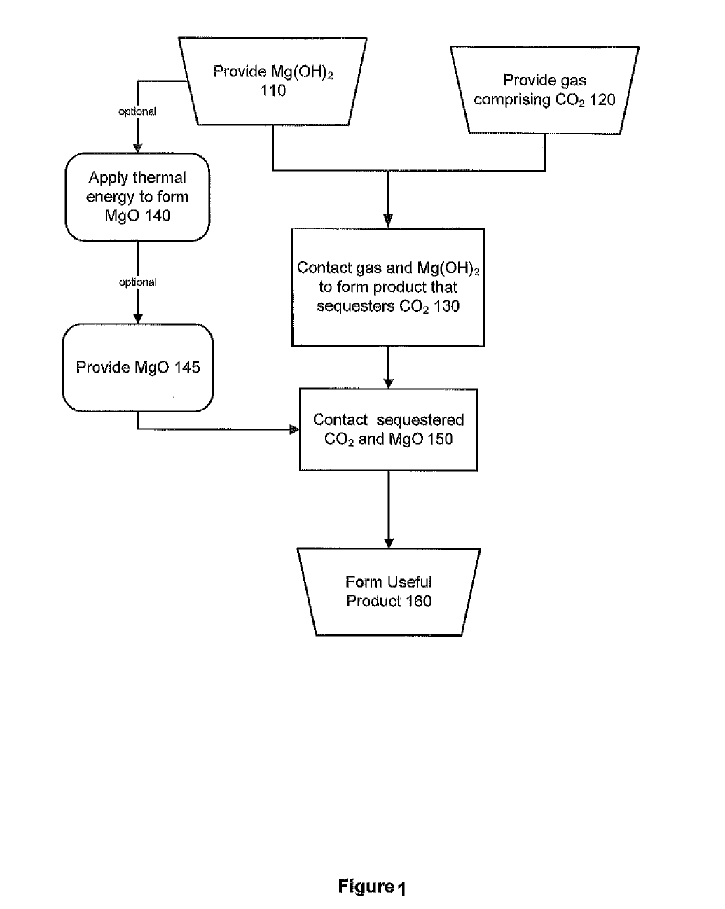

An embodiment of this invention is illustrated in FIG. 1. A reactive alkaline solution 110 comprising Mg(OH)₂ is contacted with a gas comprising carbon dioxide 120 to form a sequestered carbon dioxide product 130. In some embodiments the carbon dioxide may be supercritical carbon dioxide. In some embodiments the reactive solution may comprise a slurry of ground divalent cation containing minerals. The sequestered carbon dioxide product may comprise dissolved carbon dioxide, bicarbonate, carbonate, carbonic acid or any combination thereof. In some embodiments the sequestered carbon dioxide product may comprise a magnesium carbonate (e.g., nesquehonite MgCO₃.3H₂O or hydromagnesite Mg₅(CO₃)₄(OH)₂.4(H₂O). This product may be stored or converted into a useful product or both. The sequestered carbon dioxide product may be treated with an amount of divalent cation, e.g., calcium or magnesium ion, sufficient to convert a portion of the product into an insoluble carbonate, e.g., magnesium carbonate, calcium carbonate, or blended carbonate. In some embodiments the sequestered carbon dioxide may be reacted with magnesium oxide (MgO) 145. In some embodiments a portion of the Mg(OH)₂ may be heated to form a reactive material comprising MgO 140 and that reactive material may be contacted with the sequestered carbon dioxide 150 to form a useful product 160. In some embodiments the product may be amorphous magnesium carbonate, useful in building and construction (e.g., cement). The useful product may be a cementitious material. In some embodiments the cementitious material may be suitable for storing nuclear waste. In some embodiments a portion of the reactive material used to convert the sequestered carbon dioxide to carbonate may be the same material used to sequester the carbon dioxide from a waste gas (e.g., MgCO₃, MgO or Mg(OH)₂). One aspect of this invention is that carbon dioxide may be sequestered with a waste source of Mg(OH)₂ and require no additional energy to create proton removing agents for the sequestration of carbon dioxide.

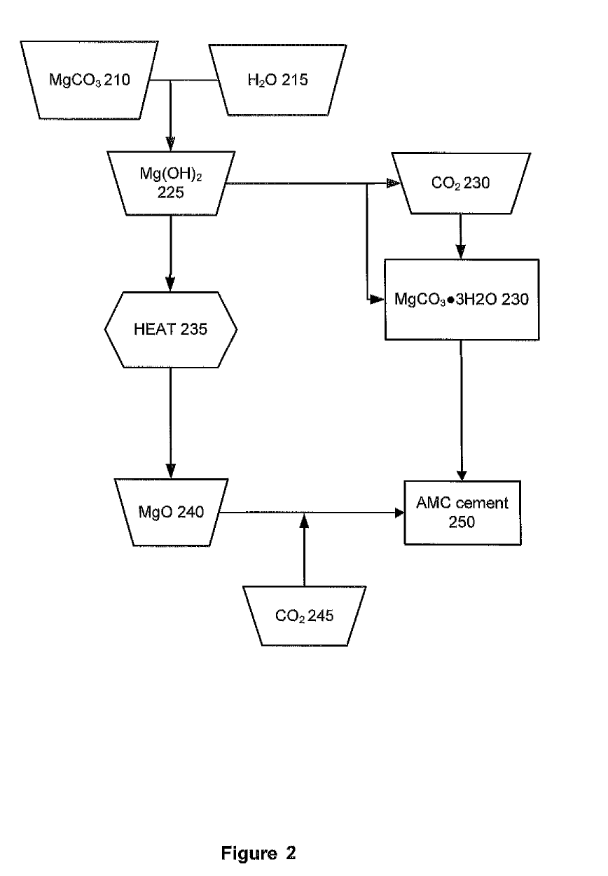

A particular embodiment of this invention is illustrated in FIG. 2. Magnesium carbonate 210 from any source, such as magnesite may be heated to MgO and mixed with water to produce magnesium hydroxide 225 and carbon dioxide 230 (Eq V). The carbon dioxide from that source or another may be combined with a portion of the magnesium hydroxide 225 to form a crystalline magnesium carbonate such as nesquehonite 230 (Eq. VI). A separate portion of the magnesium hydroxide may be converted to magnesium oxide 240 by any means such as heating 235 (Eq. VII). The magnesium oxide 240 may be contacted with the magnesium carbonate 230 and optionally with additional carbon dioxide 245 to form a CO₂ sequestering product, such as amorphous magnesium carbonate 250 (AMC) (Eqs. VII, IX). The AMC of this invention may have a mixed magnesium carbonate, bicarbonate stoichiometry so that the final product may be represented by the formula Mg_{(A)}(CO₃)_{(B)}(HCO₃)_{(C)}, where A, B, and C are any numbers. The ratio of magnesium to carbon (in the form of carbonate or bicarbonate) may be any ratio such as 1:1, 1:2, 1:3, 1:4, 1:5 etc. One aspect of this invention is the sequestration of additional carbon dioxide in an amount in excess of that derived from the carbon dioxide released upon the thermal decomposition of magnesium carbonate.

MgCO₃+H₂O→Mg(OH)₂+CO₂ (V)

Mg(OH)₂+2H₂O+CO₂→MgCO₃.3H₂O (VI)

Mg(OH)₂→MgO+H₂O (VII)

MgCO₃.3H₂O+MgO+H₂O→AMC (VIII)

MgCO₃.3H₂O+MgO+H₂O+CO₂→AMC (IX)

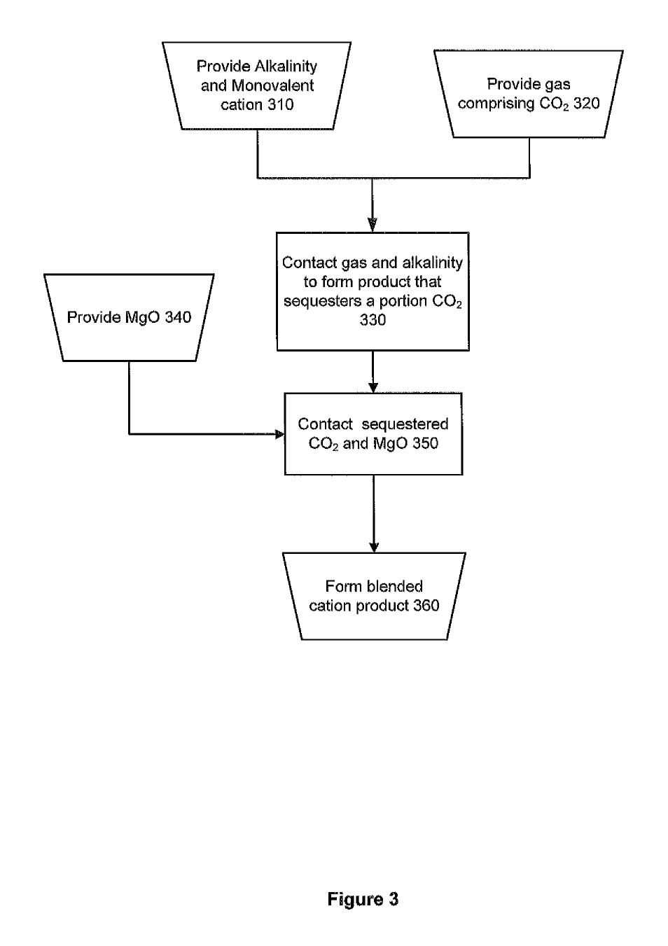

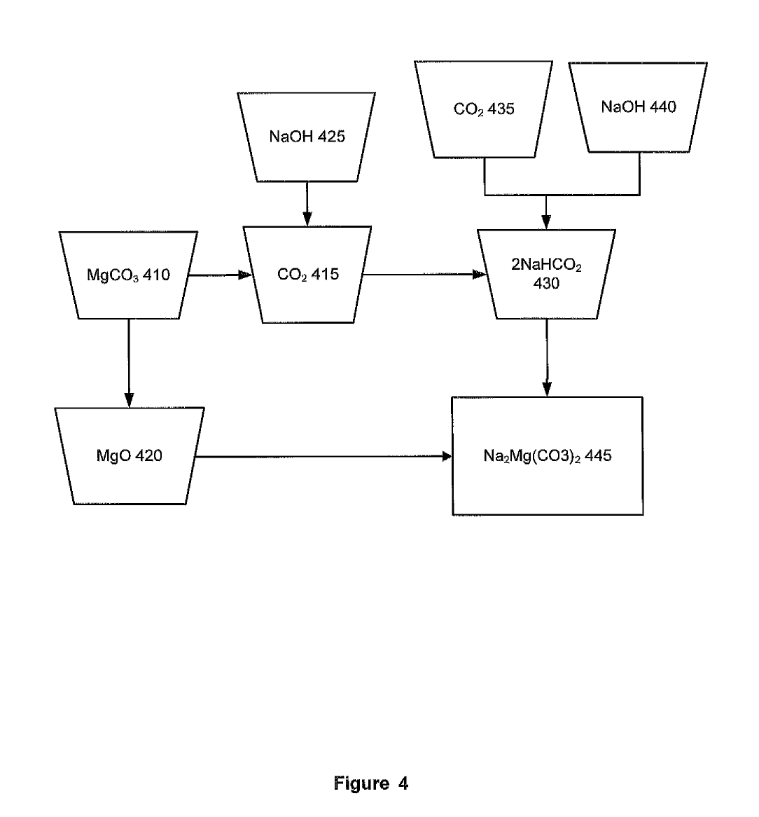

In another embodiment shown in FIG. 3, a reactive alkaline solution comprising monovalent cations such as sodium or potassium 310 may be contacted with a gas comprising carbon dioxide 320 to form a sequestered carbon dioxide product 330. The sequestered carbon dioxide product may comprise dissolved carbon dioxide, bicarbonate, carbonate, carbonic acid or any combination thereof. In some embodiments the sequestered carbon dioxide may comprise no or very little carbonate. In some embodiments the carbon in the sequestered carbon dioxide may be 50%, 60%, 70%, 80%, 90%, 95% weight percent or more bicarbonate. In some embodiments MgO may be contacted with the sequestered carbon dioxide 350 to form a product 360 comprising monovalent and divalent cations. The products may be eitelite (Na₂Mg(CO₃)₂), baylissite (K₂Mg(CO₃)₂.4H₂O), fairchildite (K₂Ca(CO₃)₂), buetschliite (K₂Ca(CO₃)₂), nyerereite (Na₂Ca(CO₃)₂), zemkorite (Na₂Ca(CO₃)₂) or K₂Ca(CO₃)₂. These materials may be useful as fillers, paper additives, fertilizers, building components and the like. In some embodiments the Mg(OH)₂ may be heated to form a reactive MgO prior to contacting the sequestered carbon dioxide. In some embodiments the source of thermal energy used to convert Mg(OH)₂ to MgO may be the same source as the gaseous carbon dioxide. One aspect of this invention enables the use of one mole of sodium hydroxide per mole of carbon dioxide to convert the carbon dioxide into a useful precipitated carbonate product. In a particular embodiment, magnesium carbonate (e.g., high Mg calcite, dolomite and the like) may be used as a feedstock for this process as well. FIG. 4 illustrates how magnesium carbonate 410 from magnesite or any other source may be calcined or otherwise decomposed into carbon dioxide 415 and magnesium oxide 420 for use in methods of this invention. The carbon dioxide may be contacted with an alkaline solution such as sodium hydroxide 425 to form a solution comprising bicarbonate 430. The bicarbonate solution may be combined with additional sequestered carbon dioxide 435 by contact with additional alkaline solution 440 to form additional bicarbonate solution 430. This may be contacted with magnesium oxide 420 to form a blended alkali metal, magnesium carbonate 445 (e.g., eitelite (Na₂Mg(CO₃)₂). One aspect of products of this invention is that the carbon in the precipitated product will have isotopic signature indicative of the source of carbon used in the production. For example precipitated products derived from flue gases or other industrial sources will have a δ¹³C value consistent with a fossil fuel such a coal or oil such as less than −10‰, or less than −15‰, or less than −25‰, or less than −26.10‰.

### Precipitation

Methods of the invention include contacting source of divalent cations with a source of sequestered carbon dioxide (e.g., carbonic acid, bicarbonate, and/or carbonate) and subjecting the resultant solution to precipitation conditions. In addition to divalent cations sourced from industrial waste or mined material, divalent cations may come from any of a number of different sources depending upon availability at a particular location. Material comprising divalent cations may also be used in combination with supplemental sources of divalent cations in order to achieve desired concentrations and compositions. Such sources include industrial wastes, seawater, subterranean brines, hard waters, minerals (e.g., lime, periclase), and any other suitable source.

In methods of the invention, a volume of sequestered carbon dioxide solution or slurry produced as described above may be subjected to carbonate compound precipitation conditions sufficient to produce a carbonate-containing precipitation material and a supernatant solution solution (i.e., the part of the precipitation reaction mixture that is left over after precipitation of the precipitation material). Any convenient precipitation condition may be employed, in which conditions result in production of a carbonate-containing precipitation material. In some embodiments the materials may comprise divalent cations from a metal silicate (optionally with SiO₂) from the CO₂-charged reaction mixture. Precipitation conditions include those that modulate the physical environment of the sequestered carbon dioxide precipitation reaction mixture to produce the desired precipitation material. For example, the temperature of the CO₂-charged precipitation reaction mixture may be raised to a point at which precipitation of the desired carbonate-containing precipitation material occurs, or a component thereof (e.g., CaSO₄(s), the sulfate resulting from, for example, sulfur-containing gas in combustion gas or sulfate from seawater). In such embodiments, the temperature of the CO₂-charged precipitation reaction mixture may be raised to a value from 5° C. to 70° C., such as from 20° C. to 50° C., and including from 25° C. to 45° C. While a given set of precipitation conditions may have a temperature ranging from 0° C. to 100° C., the temperature may be raised in certain embodiments to produce the desired precipitation material. In certain embodiments, the temperature of the precipitation reaction mixture is raised using energy generated from low or zero carbon dioxide emission sources (e.g., solar energy source, wind energy source, hydroelectric energy source, waste heat from the flue gases of the carbon dioxide emitter, etc.). In some embodiments, the temperature of the precipitation reaction mixture may be raised utilizing heat from flue gases from coal or other fuel combustion. Pressure may also be modified. In some embodiments, the pressure for a given set of precipitation conditions is normal atmospheric pressure (about 1 bar) to about 50 bar. In some embodiments, the pressure for a given set of precipitation materials is 1-2.5 bar, 1-5 bar, 1-10 bar, 10-50 bar, 20-50 bar, 30-50 bar, or 40-50 bar. In some embodiments, precipitation of precipitation material is performed under ambient conditions (i.e., normal atmospheric temperature and pressure). The pH of the CO₂-charged precipitation reaction mixture may also be raised to an amount suitable for precipitation of the desired carbonate-containing precipitation material. In such embodiments, the pH of the CO₂-charged precipitation reaction mixture is raised to alkaline levels for precipitation, wherein carbonate is favored over bicarbonate. The pH may be raised to pH 9 or higher, such as pH 10 or higher, including pH 11 or 12 or 13 or higher. For example, when a proton-removing agent source such as fly ash is used to raise the pH of the precipitation reaction mixture or precursor thereof, the pH may be about pH 12.5 or higher.

Accordingly, a set of precipitation conditions to produce a desired precipitation material from a precipitation reaction mixture may include, as above, the temperature and pH, as well as, in some instances, the concentrations of additives and ionic species in solution. Precipitation conditions may also include factors such as mixing rate, forms of agitation such as ultrasonic agitation, and the presence of seed crystals, catalysts, membranes, or substrates. In some embodiments, precipitation conditions include supersaturated conditions, temperature, pH, and/or concentration gradients, or cycling or changing any of these parameters. The protocols employed to prepare carbonate-containing precipitation material according to the invention (from start to finish may be batch, semi-batch, or continuous protocols. It will be appreciated that precipitation conditions may be different to produce a given precipitation material in a continuous flow system compared to a semi-batch or batch system. Precipitation conditions may be adjusted to promote the formation of particular polymorphs of the carbonate precipitate such as nesquehonite, hydromagnesite or amorphous magnesium carbonate.

Carbonate-containing precipitation material, following production from a precipitation reaction mixture, may be separated from the reaction mixture to produce separated precipitation material (e.g., wet cake) and a supernatant solution. The precipitation material may be stored in the supernatant solution for a period of time following precipitation and prior to separation (e.g., by drying). For example, the precipitation material may be stored in the supernatant solution for a period of time ranging from 1 to 1000 days or longer, such as 1 to 10 days or longer, at a temperature ranging from 1° C. to 40° C., such as 20° C. to 25° C. Separation of the precipitation material from the precipitation reaction mixture is achieved using any of a number of convenient approaches, including draining (e.g., gravitational sedimentation of the precipitation material followed by draining), decanting, filtering (e.g., gravity filtration, vacuum filtration, filtration using forced air), centrifuging, pressing, or any combination thereof. Separation of bulk water from the precipitation material may produce a wet cake of precipitation material, or a dewatered precipitation material suitable for additional processing.

In some embodiments, the resultant dewatered precipitation material may then dried to produce a product (e.g., a cement, building material, agricultural reagent). Drying may be achieved by air-drying the precipitation material. Where the precipitation material is air dried, air-drying may be at a temperature ranging from −70° C. to 120° C. In certain embodiments, drying is achieved by freeze-drying (i.e., lyophilization), wherein the precipitation material is frozen, the surrounding pressure is reduced, and enough heat is added to allow the frozen water in the precipitation material to sublime directly into gas. In yet another embodiment, the precipitation material is spray-dried to dry the precipitation material, wherein the liquid containing the precipitation material is dried by feeding it through a hot gas (e.g., a gaseous waste stream from the power plant), and wherein the liquid feed is pumped through an atomizer into a main drying chamber and a hot gas is passed as a co-current or counter-current to the atomizer direction. Depending on the particular drying protocol, the drying station (described in more detail below) may be configured to allow for use of a filtration element, freeze-drying structure, spray-drying structure, etc. In certain embodiments, waste heat from a power plant or similar operation may be used to perform the drying step when appropriate. For example, in some embodiments, aggregate is produced by the use of elevated temperature (e.g., from power plant waste heat), pressure, or a combination thereof.

Following separation of the precipitation material from the supernatant solution, the separated precipitation material may be further processed as desired; however, the precipitation material may simply be transported to a location for long-term storage, effectively sequestering CO₂. For example, the carbonate-containing precipitation material may be transported and placed at a long-term storage site, for example, above ground (as a storage-stable CO₂-sequestering material), below ground, in the deep ocean, etc.

In some embodiments, the method further comprises drying the precipitation material. In such embodiments, the precipitation material may be dried to form a fine powder having a consistent particle size (i.e., the precipitation material may have a relatively narrow particle size distribution). Precipitation material, as described further herein, may have a Ca²⁺ to Mg²⁺ ranging from 1:1000 to 1:1 or 1 to 1000:1. Precipitation material as described further herein may have a magnesium to carbon ratio of 1:1 or 1:2 Precipitation material may comprise MgCO₃ in any form, such as magnesite, barringtonite, nesquehonite, lansfordite, amorphous magnesium carbonate, artinite, hydromagnesite, etilite, or a combination thereof. Precipitation material comprising CaCO₃ may comprise calcite, aragonite, vaterite, ikaite, amorphous calcium carbonate, monohydrocalcite, or combinations thereof. In some embodiments the precipitation material may be greater that 50% vaterite. In some embodiments, the method further comprises processing the precipitation material to produce a construction material. In such embodiments, the construction material is an aggregate, cement, cementitious material, supplementary cementitious material, or a pozzolan.

### Systems

Where the CO₂ is a gas, it may be sequestered by contact protocols of interest that include, but are not limited to direct contacting protocols (e.g., bubbling the CO₂ gas through the aqueous solution), concurrent contacting means (i.e., contact between unidirectional flowing gaseous and liquid phase streams), countercurrent means (i.e., contact between oppositely flowing gaseous and liquid phase streams), and the like. As such, contact may be accomplished through use of infusers, bubblers, fluidic Venturi reactors, spargers, gas filters, sprays, trays, or packed column reactors, and the like, as may be convenient. In some embodiments, gas-liquid contact is accomplished by forming a liquid sheet of solution with a flat jet nozzle, wherein the CO₂ gas and the liquid sheet move in countercurrent, co-current, or crosscurrent directions, or in any other suitable manner. In some embodiments the contact liquid is an alkaline solution. In some embodiment the contact liquid comprises Mg(OH)₂ or MgO. In some embodiments the alkaline solution is generated from an electrochemical reaction that is configured to generate no chlorine gas or no gas at the anode. In some embodiments, gas-liquid contact is accomplished by nebulizing a precursor to the precipitation reaction mixture such that contact is optimized between droplets of the precipitation reaction mixture precursor and a source of CO₂. In some embodiments, gas-liquid contact is accomplished by contacting liquid droplets of solution having an average diameter of 500 microns or less, such as 100 microns or less, with the CO₂ gas source. In some embodiments, a catalyst is used to accelerate the dissolution of carbon dioxide into solution by accelerating the reaction toward equilibrium; the catalyst may be an inorganic substance such as zinc dichloride or cadmium, or an organic substance such as an enzyme (e.g., carbonic anhydrase).

In some embodiments a gas comprising carbon dioxide is contacted with a reactive first solution using a gas-liquid contacting apparatus (i.e., absorber). The absorber in the carbon dioxide contacting system may be a packed bed absorber with one or two or more zones of gas-liquid contact. In some embodiments two or more absorbers may be utilized to house two or more zones of contact. Thus in some embodiments the invention provides an apparatus for separating carbon dioxide from an industrial waste stream that comprises a gas-liquid contactor that is configured to contact one or more streams of a liquid, e.g., alkaline solutions, with all or a portion of the industrial waste stream to dissolve CO₂ in two or more zones of contact. In some embodiments, the sequestered carbon dioxide product comprises bicarbonates, carbonates or any combination thereof. In some embodiments, a solid composition is generated that comprises carbonates and/or bicarbonates and also one or more further components of the industrial waste gas, e.g., SOₓ or a SOₓ derivative, NOₓ or a NOₓ derivative, a heavy metal or derivative thereof, particulates, VOCs or a VOC derivative, or a combination thereof.

The absorption vessel may be operably connected to a precipitation reaction vessel. The precipitation reaction vessel may be further configured for adjusting and controlling precipitation reaction conditions such as one or more precipitation control systems. For example, the precipitation reaction vessel may have a temperature probe and heating element, both of which may be used to control the temperature of the precipitation reaction mixture. A liquid-solid separator may be operably connected to the precipitation reaction vessel and configured to receive precipitation reaction mixture from the precipitation reaction vessel. The liquid-solid separator may be further configured to separate the precipitation reaction mixture into two streams, which streams comprise supernatant solution and precipitation material. The resultant precipitation material may be a relatively moist solid or a slurry more rich in precipitation material than the original precipitation reaction mixture, either of which may optionally be provided to a dryer configured to receive concentrated precipitation material.

A dryer (e.g., spray dryer), which may accept waste heat from the industrial waste source of CO₂, may produce a dried precipitation or pozzolanic material. The source of the waste gas operably connected to a precipitation reactor and or the dryer may be, in some embodiments, a fossil fuel-fired power plant, a refinery, or some other industrial process that emits an exhaust gas with an elevated concentration of CO₂ relative to the atmospheric level of CO₂. In some embodiments, such exhaust gas is produced by a combustion reaction and therefore the exhaust gas carries residual heat from the combustion reaction. If the distance from the source of the exhaust gas is extensive, or if the exhaust gas is otherwise not sufficiently hot for the purpose of spray drying, a gas heating unit may be placed between the source of the exhaust gas and the spray dryer to boost the temperature of the exhaust gas. It will be appreciated that, in addition to oxidizing exhaust gases produced by combustion, the source of the exhaust gas may be replaced with a source of a reducing gas such as syngas, shifted syngas, natural gas, hydrogen, or the like, so long as the reducing gas includes CO₂. Other suitable multi-component gaseous streams include turbo charged boiler product gas, coal gasification product gas, shifted coal gasification product gas, anaerobic digester product gas, wellhead natural gas streams, reformed natural gas or methane hydrates, and the like.

### EXAMPLES

### Example 1

Formation of Eitilite

200 grams of Mg(OH)₂ were placed in aluminate crucible. The sample was heated for 2 hour at 675° C. to form MgO powder. It was removed from the furnace and the presence of MgO was confirmed using X-ray diffraction (XRD). Powdered NaHCO₃ or MgCO₃ was blended with powdered MgO according to mix design table indicated below. Distilled (DI) water was added according the mix design table below to create a paste.

TABLE 1
Experimental Mix Protocol

| MgO (g) | NaHCO₃ (g) | MgCO₃ (g) | H₂O (g) |
|---|---|---|---|
| 2 | 6 | | 3 |
| 4 | 4 | | 5 |
| 2 | 4 | | 3 |
| 6 | 2 | | 7 |
| 2 | | 6 | 4 |
| 4 | | 4 | 5 |
| 6 | | 2 | 7 |

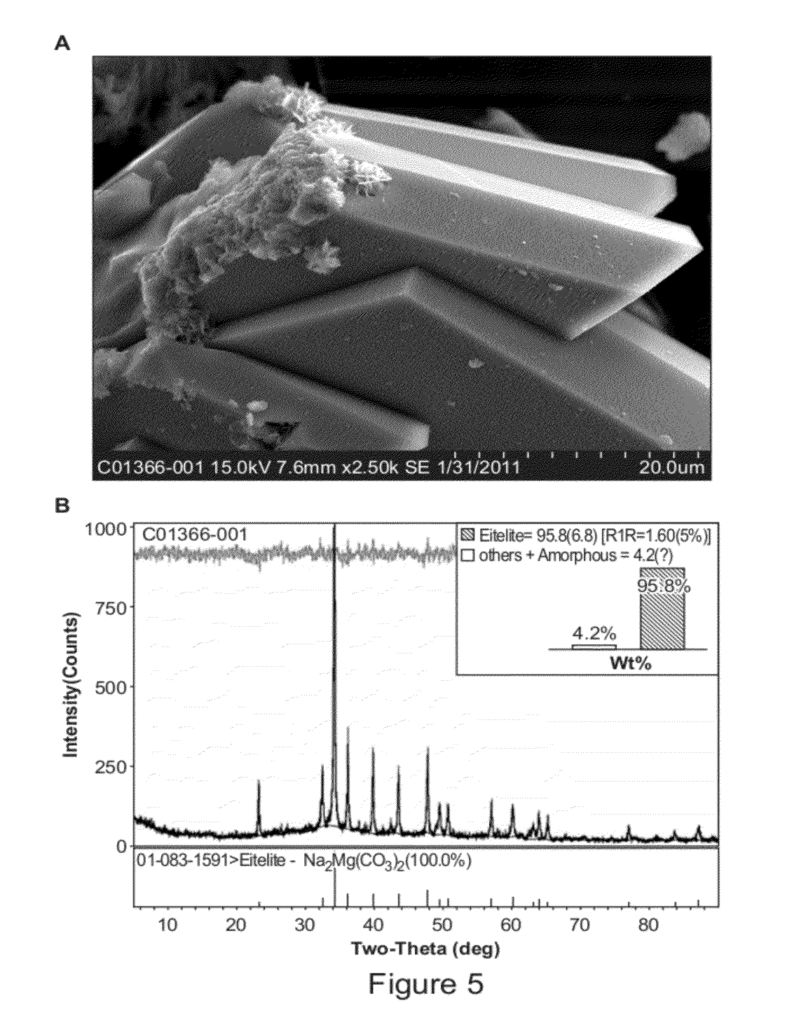

The paste was allowed to cure for 5 days and samples were submitted to XRD and scanning electron microscope (SEM) analysis. FIGS. 5A and B show the SEM and XRD results of a cured paste formed from 2 g MgO, 4 g NaHCO₃, and 3 g DI H₂O. The crystal structure is consistent with Eitelite (Na₂Mg(CO₃)₂).

### Example 2

### Formation of MgCO₃ from Synthetic Brine

Desalination retentate is normally a waste product of the water desalination processes and is rich in magnesium and calcium as well as other ions in solution. These waste sources can be useful, providing divalent cations to the carbon dioxide sequestration process resulting in calcium and magnesium carbonates. Synthetic retentate brine was prepared with molar amounts of Mg and Ca. These brines were used as divalent cation source for precipitation experiments. Precipitation experiments were performed both by way of dosing with sodium carbonate as well as sparging with CO₂ and dosing with sodium hydroxide (NaOH).

### Sample P01810:

133.39 g MgCl₂.2H₂O and 14.53 g CaCl₂.2H₂O were blended into 4.75 L deionized water to generate a brine corresponding to 0.16M Ca and 0.08M Mg (final molarity). The material was sparged with pure CO₂ and dosed with a total 104 g 50% NaOH blended into 250 mL DI T1 water (accounting for 5 L final volume of precipitation). The retentate was sparged with pure CO₂ to a pH of 4.13. Sodium hydroxide was added until pH was 9.7. Sparging and dosing with sodium hydroxide was continued until all base was applied over 1 hour. The final pH was 8.5 pH. The precipitate was analyzed by XRD, SEM and FT-IR

### Sample P01818:

133.39 g MgCl₂.2H₂O and 14.53 g CaCl₂.2H₂O were blended into 4.75 L deionized water to for a brine corresponding to 0.16M Ca and 0.08M Mg (final molarity). The material was sparged with pure CO₂ and dosed with a total of 50 g 50% NaOH blended into 250 mL DI T1 water (accounting for 5 L final volume of precipitation). The retentate was sparged with pure CO₂ to a pH of 5.5. Sodium hydroxide was added until pH was 8.5. Sparging and dosing with sodium hydroxide was continued until all base was applied over 45 minutes. The final pH was 9.3 pH. The precipitate was analyzed by XRD, SEM and FT-IR

### Sample P01823:

133.39 g MgCl₂.2H₂O and 14.53 g CaCl₂.2H₂O were blended into 4.75 L deionized water to for a brine corresponding to 0.16M Ca and 0.08M Mg (final molarity). The material was sparged with pure CO₂ and dosed with a total 119.5 g 50% NaOH blended into 250 mL DI T1 water (accounting for 5 L final volume of precipitation). The retentate was sparged with pure CO₂ to a pH of 5.5. Sodium hydroxide was added until pH was 9.7. Sparging and with sodium hydroxide was continued until all base was applied over 45 minutes. The final pH was 9.3 pH. The precipitate was analyzed by XRD, SEM and FT-IR

Analytical Analysis of Precipitates:

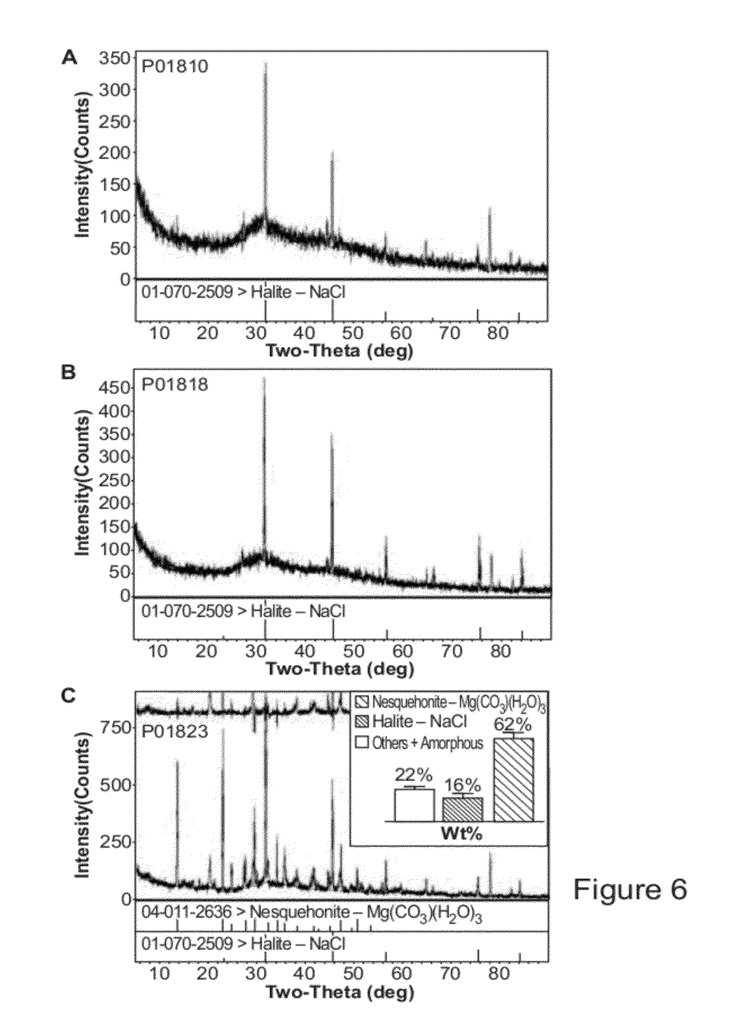

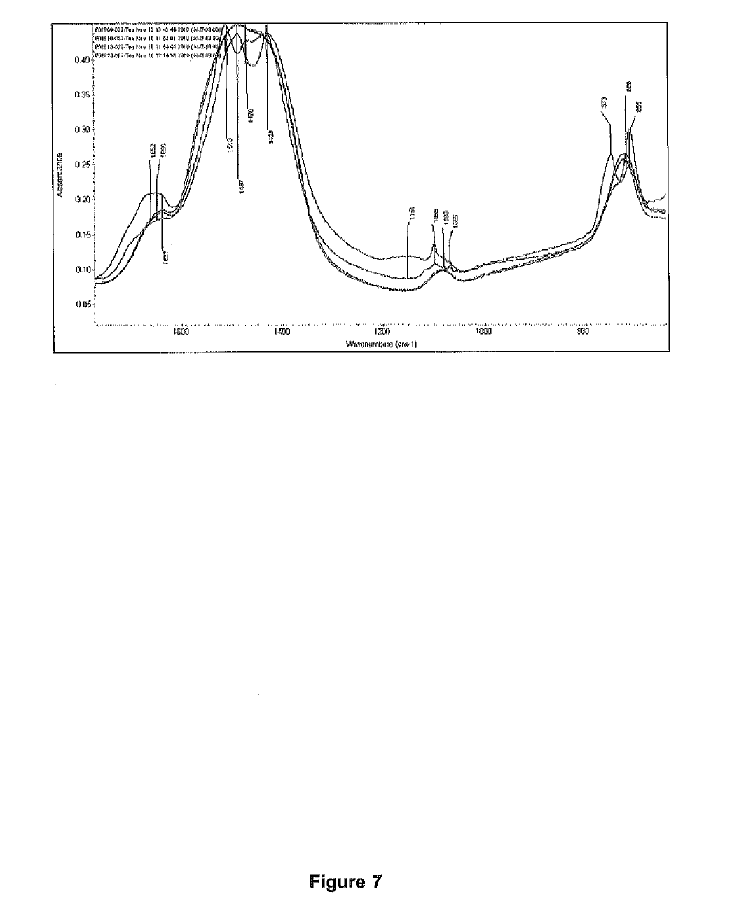

All precipitates were dried at 40° C. and submitted for XRD, Fourier transform infrared (FT-IR), Coulometry and SEM analysis. The XRD analyses are shown in FIG. 6 and indicate the presence of amorphous MgCO₃ in all three samples and nesquehonite in Sample C (P01823). The XRD data for Sample A (P01810) indicates amorphous MgCO₃ with halite presence. The XRD data for Sample B (P01818) indicates amorphous MgCO₃ with halite presence. While, the XRD data for Sample C (P01823) indicates 62% nesquehonite, 16% halite and 22% amorphous MgCO₃. FT-IR data FIG. 7 shows similar results. Sample P01810 shows spectra consistent with the presence of hydromagnesite, calcite, and aragonite. Sample P01818 shows spectra consistent with the presence of hydromagnesite, calcite, and aragonite. Sample P01823 shows spectra consistent with the presence of nesquehonite, hydromagnesite, and aragonite.

Precipitation of nesquehonite and amorphous magnesium carbonate from an ionic medium mimicking molar concentrations of calcium and magnesium in desalination retentate is possible with proper dosing of either base such as NaOH or carbonate. The materials formed with low stoichiometric ratios of base are amorphous material. Residual hardness of supernatant solution is significantly lower in precipitates dosed with stoichiometrically equimolar amounts of base, allowing for dual deprotonation and binding with divalent ions of charge balance. The materials, which were X-ray amorphous coincidentally, exhibited FT-IR peaks indicative of hydromagnesite, calcite and aragonite. Tendencies exhibiting calcium carbonate phases were seen as well in FT-IR response in other samples. XRD and FT-IR patterns of precipitates show the presence of variant phases and amorphous content due to the wavelength inherent in testing technique. XRD may be more quantitative for crystalline materials however FT-IR may indicate trace levels and trace variance more acutely.

### Example 3

### Formation of MgCO₃ from Mg(OH)₂ and CO₂

### Sample P001832:

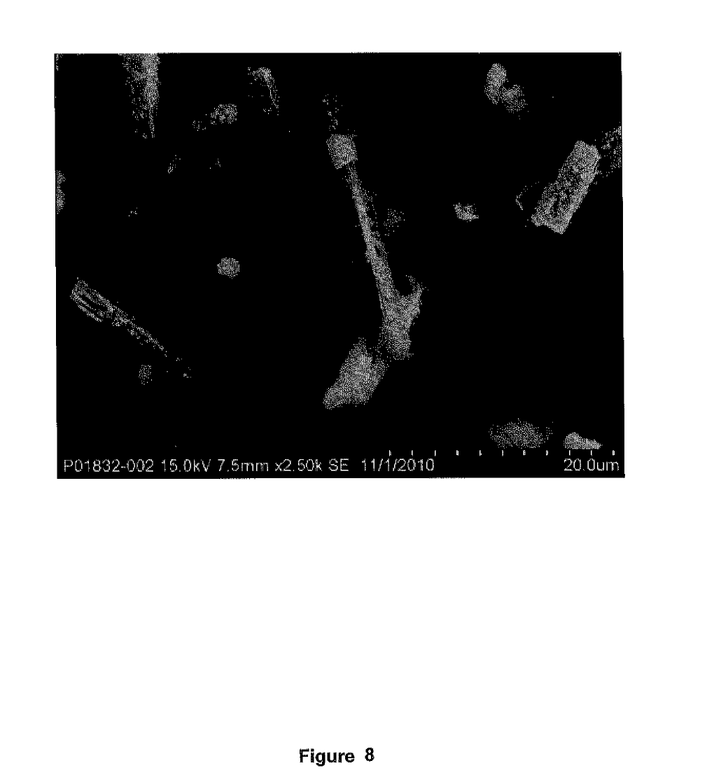

Twenty grams of Mg(OH)₂ were added to 2 liters deionized water and stirred. CO₂ was sparged into the mixture and stirred continuously for 8 hours. A precipitate was filtered and dried overnight at 40° C. overnight. SEM analysis of the precipitate shown in FIG. 8 indicates the presence of nesquahonite.

Although the foregoing invention has been described in some detail by way of illustration and example for purposes of clarity of understanding, it is readily apparent to those of ordinary skill in the art in light of the teachings of this invention that certain changes and modifications may be made thereto without departing from the spirit or scope of the appended claims.

Accordingly, the preceding merely illustrates the principles of the invention. It will be appreciated that those skilled in the art will be able to devise various arrangements which, although not explicitly described or shown herein, embody the principles of the invention and are included within its spirit and scope. Furthermore, all examples and conditional language recited herein are principally intended to aid the reader in understanding the principles of the invention and the concepts contributed by the inventors to furthering the art, and are to be construed as being without limitation to such specifically recited examples and conditions. Moreover, all statements herein reciting principles, aspects, and embodiments of the invention as well as specific examples thereof, are intended to encompass both structural and functional equivalents thereof. Additionally, it is intended that such equivalents include both currently known equivalents and equivalents developed in the future, i.e., any design features developed that perform the same function, regardless of structure. The scope of the present invention, therefore, is not intended to be limited to the exemplary embodiments shown and described herein. Rather, the scope and spirit of present invention is embodied by the appended claims.

That which is claimed is:

1. A method comprising:
a) contacting a gas comprising carbon dioxide with an aqueous alkaline mixture comprising an alkaline metal cation; wherein contacting the gas promotes an acid-base reaction between the carbon dioxide and the aqueous alkaline mixture to form a first product; and
b) contacting the first product with MgO to form a second product comprising a precipitated material.

2. The method of claim 1, wherein the aqueous alkaline mixture comprises Mg(OH)₂.

3. The method of claim 1, further comprises producing the MgO by applying thermal energy to brucite or industrial waste comprising Mg(OH)₂.

4. The method of claim 1, wherein the first product comprises MgCO₃.xH₂O and x is any number from 1-10.

5. The method of claim 1, wherein the first product comprises nesquehonite.

6. The method of claim 1, wherein the second product comprises amorphous magnesium carbonate.

7. The method of claim 1, wherein the second product is cementitious.

8. The method of claim 6, wherein the MgCO₃ is hydromagnesite.

9. The method of claim 1, wherein the precipitated material comprises a magnesium carbonate in the form of A₂Mg(CO₃)₂, wherein A is an alkaline metal.

10. The method of claim 9, wherein A is sodium.

11. The method of claim 1, wherein the precipitated material comprises eitelite, baylissite, or any combination thereof.

12. The method of claim 1, wherein the gas is a waste gas stream from an industrial plant selected from power plants, cement plants, smelters, and coal processing plants.

13. A system comprising,
a) a reaction vessel operably connected to a source of thermal energy and configured to withstand alkaline conditions and to provide thermal energy to a reaction mixture; and
b) a gas liquid absorber operably connected to the reaction vessel and a source of gas comprising carbon dioxide and an output vessel, wherein the gas liquid absorber is configured to promote contact between the gas comprising carbon dioxide and the reaction mixture.

14. The system of claim 13, wherein the source of thermal energy is selected from a power plant, cement plant, or smelter.

15. The system of claim 13, wherein the source of gas is selected from a power plant, cement plant, or smelter.

16. The system of claim 13, wherein the source of gas and the source of thermal energy is the same.

17. A composition comprising mixed monovalent and divalent carbonate comprising eitelite, baylissite, or any combination thereof, wherein the composition has a relative carbon isotope composition (δ¹³C) value less than −15.0‰.

18. The composition of claim 17, wherein the composition further comprises magnesium carbonate in the form of Mg_{A}(CO₃)_{B}(HCO₃)_{c} wherein B+C is greater than A.

19. The composition of claim 18, wherein the composition is cementitious.

20. The composition of claim 18, comprising greater than 20 wt % magnesium carbonate.
